(19) United States
(12) Patent Application Publication
(10) Pub. No.: US 2026/0072896 A1
(43) Pub. Date: Mar. 12, 2026

(54) DATA VALIDATION TECHNIQUES USING MULTIPLE LAYERED SCHEMAS

(71) Applicant: Microsoft Technology Licensing, LLC, Redmond, WA (US)

(72) Inventors: Xinyu LIU, Redmond, WA (US); John BERKELEY, Kenmore, WA (US); Kristofer D. HOFFMAN, Sammamish, WA (US)

(73) Assignee: Microsoft Technology Licensing, LLC, Redmond, WA (US)

(21) Appl. No.: 18/828,520

(22) Filed: Sep. 9, 2024

(51) Int. Cl. G06F 16/23; G06F 16/21

(52) U.S. Cl. CPC G06F 16/2365; G06F 16/212

(57) ABSTRACT

A data processing system implements obtaining a string representing a JSON object at a JSON validator; obtaining a JSON schema for validating the JSON object using the JSON validator, the JSON schema specifying one or more first constraints on the data of the JSON object must be satisfied in order for the JSON object to be valid against the JSON schema; determining, using the JSON validator, that the JSON schema references one or more JSON subschemas, the one or more JSON subschemas specifying one or more second constraints on the data of the JSON object must be satisfied in order for the JSON object to be valid; validating the JSON object using the JSON schema and the one or more JSON subschemas; and performing one or more actions using the JSON object in response to validating the JSON object.

### BACKGROUND

JavaScript Object Notation (JSON) is a lightweight, data interchange format and standard file format. JSON is used to store and transmit data objects as human-readable text. These data objects consist of key-value pairs (also referred to as name-value pairs). A key may be any string value used to identify the key-value pair. A value may be a string, number, a Boolean value (true or false), a null value, an object, or an array. An array is an ordered collection of values separated by a comma.

JSON schemas provide a means for validating the content of JSON objects. A JSON validator compares the values and structure of a JSON object with a JSON schema associated with the JSON object to identify errors in the values or structure of the JSON object. Such validators are commonly used to ensure that data that is being sent and/or received in JSON format is valid. A technical shortcoming of this approach is that the size and complexity of the JSON schemas can grow quickly, making the task of maintaining and utilizing the JSON schemas more challenging. Hence, there is a need for improved systems and methods for constructing the JSON schemas used for validating JSON objects.

### SUMMARY

An example data processing system according to the disclosure may include a processor and a machine-readable medium storing executable instructions. The instructions when executed cause the processor alone or in combination with other processors to perform operations including obtaining a string representing a JavaScript Object Notation (JSON) object at a JSON validator, the JSON object comprising data generated by a first component of a cloud-based computing environment; obtaining a JSON schema for validating the JSON object using the JSON validator, the JSON schema specifying one or more first constraints on the data of the JSON object must be satisfied in order for the JSON object to be valid against the JSON schema; determining, using the JSON validator, that the JSON schema references one or more JSON subschemas, the one or more JSON subschemas specifying one or more second constraints on the data of the JSON object must be satisfied in order for the JSON object to be valid against the one or more JSON subschemas; obtaining the one or more JSON subschemas using the JSON validator; validating the JSON object using the JSON schema and the one or more JSON subschemas by comparing the JSON object with the JSON schema and the one or more JSON subschemas; and performing one or more actions using the JSON object in response to validating the JSON object.

An example method implemented in a data processing system includes obtaining a string representing a JavaScript Object Notation (JSON) object at a JSON validator, the JSON object comprising data generated by a first component of a cloud-based computing environment; obtaining a JSON schema for validating the JSON object using the JSON validator, the JSON schema specifying one or more first constraints on the data of the JSON object must be satisfied in order for the JSON object to be valid against the JSON schema; determining, using the JSON validator, that the JSON schema references one or more JSON subschemas, the one or more JSON subschemas specifying one or more second constraints on the data of the JSON object must be satisfied in order for the JSON object to be valid against the one or more JSON subschemas; obtaining the one or more JSON subschemas using the JSON validator; validating the JSON object using the JSON schema and the one or more JSON subschemas by comparing the JSON object with the JSON schema and the one or more JSON subschemas; and performing one or more actions using the JSON object in response to validating the JSON object.

An example data processing system according to the disclosure may include a processor and a machine-readable medium storing executable instructions. The instructions when executed cause the processor alone or in combination with other processors to perform operations including obtaining a string representing a JavaScript Object Notation (JSON) object at a JSON validator; obtaining a JSON schema for validating the JSON object using the JSON validator, the JSON schema specifying one or more first constraints on the data of the JSON object must be satisfied in order for the JSON object to be valid against the JSON schema; determining, using the JSON validator, that the JSON schema is a multilayer schema that references one or more JSON subschemas that specify one or more second criteria that the JSON object must satisfy; obtaining the one or more JSON subschemas using the JSON validator; validating the JSON object using the JSON schema and the one or more JSON subschemas by determining whether contents of the JSON object satisfy the one or more first constraints and the one or more second constraints; and performing one or more actions using the JSON object in response to validating the JSON object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A-1E are diagrams showing an example multilevel schema that can be generated and/or utilized according to the techniques disclosed herein.

FIG. 2 is a diagram showing an example implementation of object classes that implement the multilevel schema shown in FIGS. 1A-1E.

FIG. 3 is a diagram showing an example implementation of a JSON validator that can implement the techniques disclosed herein.

FIG. 4 is a diagram showing an example computing environment in which the techniques disclosed herein are implemented.

FIG. 5 is a flow chart of an example process for validating a JSON object using a multilayer JSON schema according to the techniques described herein.

FIG. 6 is a flow chart of another example process for validating a JSON object using a multilayer JSON schema according to the techniques described herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Techniques for validating data using multilayer schemas are provided herein. These techniques provide a technical solution to the technical problems associated with using JSON schemas to validate JSON objects. Currently a single, static JSON schema can be used to validate JSON objects. Consequently, the JSON schema can become very complex, making creating and maintaining these JSON schemas a challenging and labor-intensive process. The techniques herein provide support for multilayer schemas that enable a schema to reference one or more subschemas. A technical benefit of this approach is that it facilitates the development of smaller and interchangeable schemas for improved readability and reusability that can be referenced by another schema and/or can reference another schema. This approach enables a JSON object to be validated by comparing the JSON object against a single JSON schema as in the current approaches, but that JSON schema can reference other reusable and interchangeable JSON schemas. These and other technical benefits of the techniques disclosed herein will be evident from the discussion of the example implementations that follow.

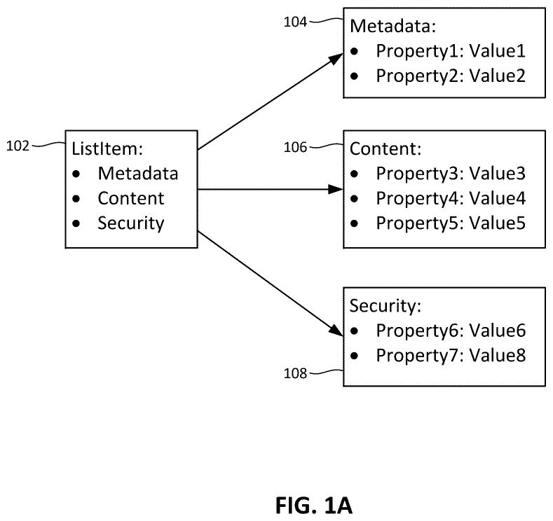

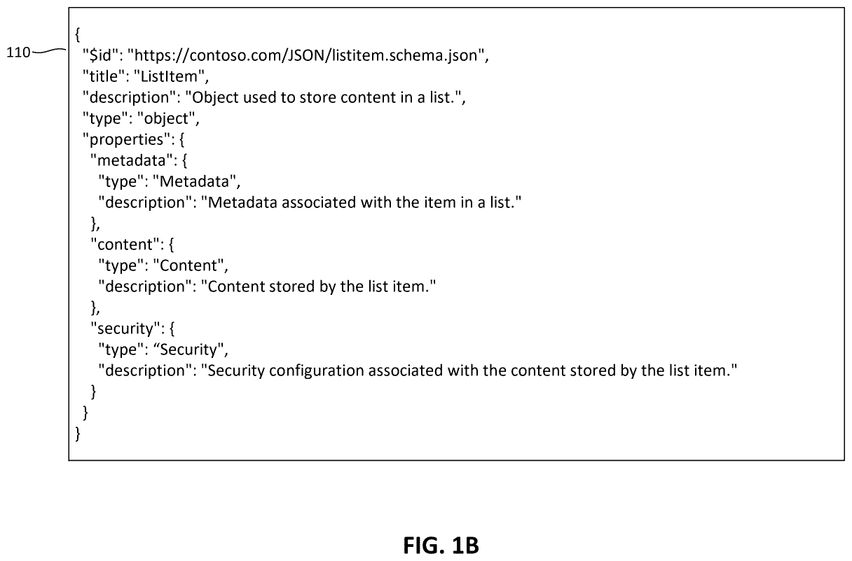

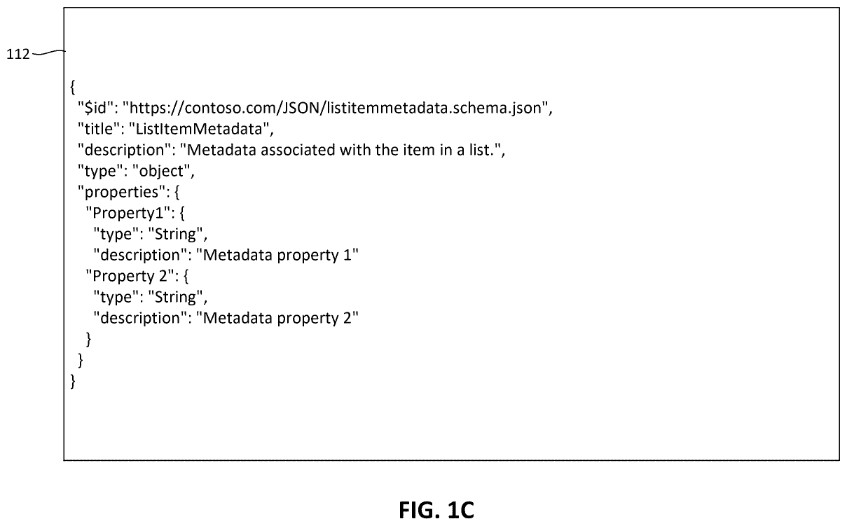

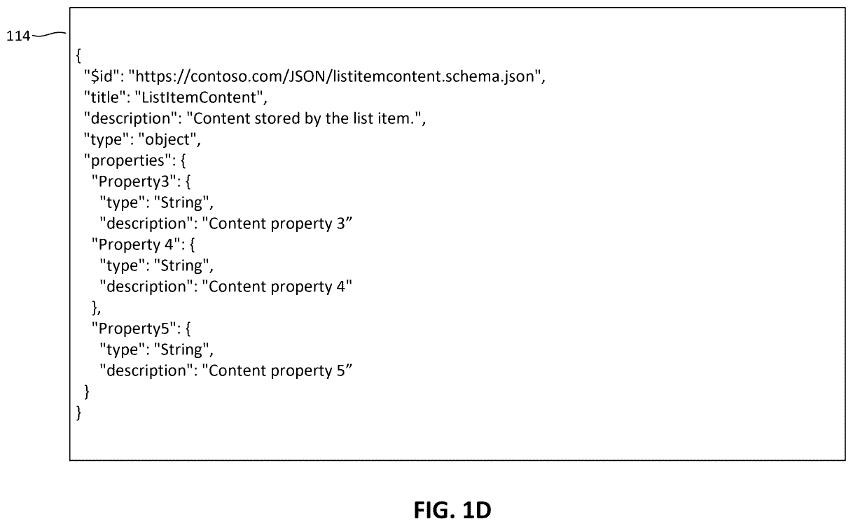

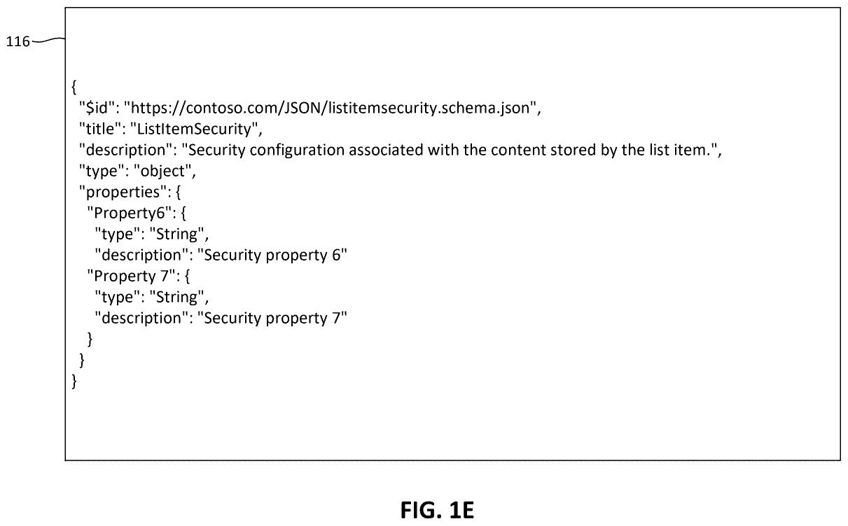

FIGS. 1A-1E are diagrams showing an example multilevel schema that can be generated and/or utilized according to the techniques disclosed herein. FIG. 1A shows an example ListItem object 102 that can be represented as a JSON object. The ListItem object 102 is used to store data associated with an entry in a List or Array object. In the example shown in FIG. 1A, the ListItem object 102 includes three members: a ListItemMetadata object 104, a ListItemContent object 106, and a ListItemSecurity object 108.

A JSON can be created that specifies one or more rules or constraints on the data of the JSON object that must be satisfied in order for the JSON object to be valid against the JSON schema. A JSON validator can use the JSON schema to ensure that a JSON object satisfies the rules and constraints specified by the JSON schema. In current JSON schema implementations, the JSON schema must include a definition of all of the objects to be validated in a JSON object. For example, the JSON schema to validate the ListItem object 102 shown in FIG. 1A would need to also include definitions of the ListItemMetadata object 104, the ListItemContent object 106, and the ListItemSecurity object 108. Consequently, the JSON schema can quickly become complex and challenging to create and maintain.

The techniques herein address this problem and other technical problems associated with current JSON schemas by providing multilayer schemas that enable a schema to reference one or more subschemas. This approach enables the development of smaller and interchangeable schemas for improved readability and reusability as shown in FIGS. 1B-1E. FIG. 1B provides an example ListItem schema 110 that can be used to validate the ListItem object shown in FIG. 1A. The ListItem schema 110 references the ListItemMetadata object 104, the ListItemContent object 106, and the ListItemSecurity object 108, but the definitions of these objects have been provided in separate JSON schemas 112, 114, and 116 shown in FIGS. 1C-1E. While the examples shown in FIG. 1B provides an example of a multilayer schema that references a set of subschemas that are defined in a second layer, other implementations may include multiple layers of subschemas. For instance, the JSON schemas 112, 114, and 116 can define one or more properties. Properties are key-value pairs where each key is the name of a property, and each value is a schema used to validate that property. By default, properties which are defined for a schema are not required in JSON objects for the JSON object to be valid. However, the JSON schema can define certain properties as required properties. A JSON object that does not include a required property will be considered invalid. In addition, the value of each property is assigned a certain type, e.g., string, number, Boolean, null, object, and array. A JSON object having a property with a value of the wrong type (e.g., a value of null where string type is required) can make the object invalid even if the property is not a required property.

As discussed in greater detail in the examples which follow, the JSON validator determines that the ListItem schema 110 includes references to objects defined in other schemas. The JSON validator obtains and parses these subschemas. In some implementations, the structure of the multilayer schema can be represented as a tree structure with the root being the JSON schema and the JSON subschemas representing nodes in the tree structure. The JSON validator can iteratively examine each of the layers of subschemas referenced in the JSON schema to obtain the rules and constraints included in these subschemas. The JSON validator combines the definitions from the JSON schema and the JSON subschemas that provide the rules and constraints for determining whether the data in the JSON object is valid and combines these definitions into a single schema to be compared with the JSON object. The JSON validator will validate JSON objects which have the requisite required properties and that have the correct property value types for required properties and other properties which are included in the JSON object. Additional details of the operation of the JSON validator are provided in the example implementations which follow.

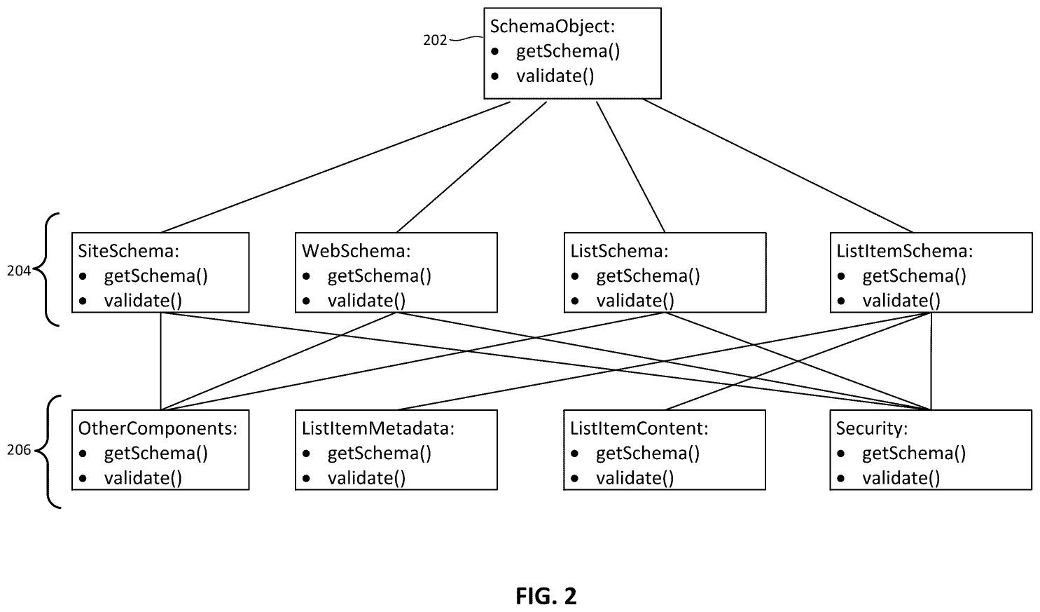

FIG. 2 is a diagram showing an example implementation of object classes that implement a multilevel schema, such as that shown in FIGS. 1A-1E. In some implementations, the JSON validator instantiates an object based on the JSON object string to facilitate validating the JSON object string. The object classes include a template schema object 202 that every schema and/or subschema must follow. The root schemas 204 implement the schema defined by the template schema. Furthermore, the components 206 implement one or more of the root schemas 204. The components 206 can also serve as a root schema for additional types of objects. The template schema object 202 provides that the root schemas 204, the components 206, and/or other components that depend therefrom, with the means for correctly implement validation in order to obtain correct validation results.

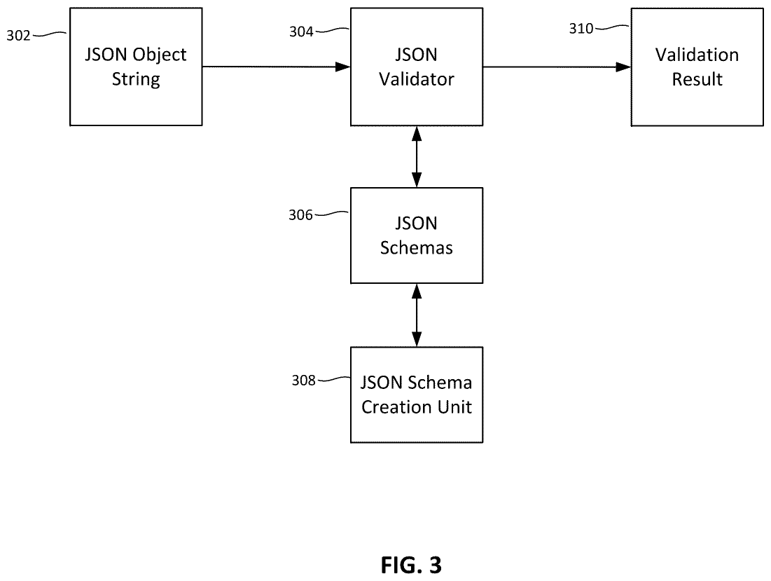

FIG. 3 is a diagram showing an example implementation of a JSON validator 304 that can implement the techniques disclosed herein. The JSON validator 304 can be implemented by a component of a computing environment that generates the JSON object string 302. This enables the component to validate the JSON object string 302 before providing the JSON object string to another component of the computing environment. The JSON validator 304 can also be implemented by a component of a computing environment that receives the JSON object string 302 and validates the JSON object to ensure that the JSON object string 302 is valid before processing the JSON object. In yet other implementations, the JSON validator 304 is implemented as a separate process or service from the components that generate or consume the JSON object string 302. In such implementations, the JSON validator 304 is provided the JSON object string by the component that generated the JSON object and/or received the JSON object to obtain an indication whether the JSON object represented by the JSON object string 302 is valid.

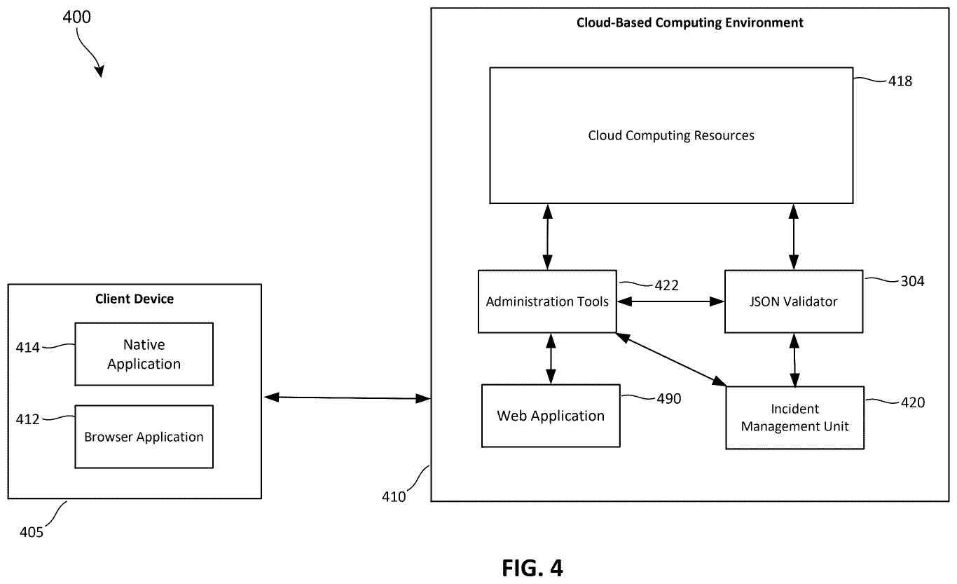

The JSON validator 304 obtains the JSON schema for the JSON object string 302 from among the JSON schemas 306. The JSON validator 304 may access the same JSON schema which is a top-level multilayer schema that references all or a subset of the other JSON schemas. The JSON validator 304 may also select a specific JSON schema that is associated with the type of JSON object represented by the JSON object string 302. This JSON schema may be a multilayer schema, such as that shown in the preceding examples. The JSON validator 304 outputs a validation result 310 that indicates whether the JSON object string 302 is valid. The validation result 310 may be provided to another component of the computing environment, such as but not limited to a component that generated or received the JSON object string 302, which can then take one or more actions in response to the validation result. In other implementations, the JSON validator 304 or another component of the computing environment can generate an incident report indicating that the JSON object string 302 was invalid. Additional details of such an implementation are discussed with respect to FIG. 4.

The JSON schemas 306 can be generated using the JSON schema creation unit 308. The JSON schema creation unit 308 provides a user interface that enables a user to create a new JSON schema to be included in the JSON schemas 306 or to modify or delete an existing JSON schema of the JSON schemas 306.

FIG. 4 is a diagram showing an example computing environment 400 in which the techniques disclosed herein are implemented. The example computing environment 400 includes a cloud-based computing environment 410 and a client device 405. The cloud-based computing environment 410 provides cloud computing resources 418 to support cloud-based computing. The computing resources can support one or more cloud-based applications and/or services to users. The cloud-based computing environment 410 can also allocate at least a portion of the cloud computing resource 418 to one or more tenants which are allocated at least a portion of the cloud computing resource 418 based on the subscription to these services. The cloud computing resource 418 can include a variety of components that exchange data to support the various applications and/or services provided by the cloud-based computing environment 410. This data can be exchanged using JSON object strings, such as those discussed in the preceding examples. The components sending these strings and/or receiving these JSON object strings can be configured to utilize the JSON validator 304 to validate the JSON object strings according to the techniques discussed herein. In the example implementation shown in FIG. 4, the JSON validator 304 is implemented as a separate service that components of the cloud computing resources 418 and/or other components of the cloud-based computing environment 410 utilize to validate JSON object strings. However, in other implementations, the functionality of the JSON validator 304 can be implemented as a software library that enables these components to implement the functionality of the JSON validator 304 directly.

The cloud-based computing environment 410 also includes administration tools 422, web application 490, and incident management unit 420. The administration tools 422 provide tools for monitoring the status of and/or configuring components of the cloud computing resources 418. The administration tools 422 can be configured to permit administrators associated with tenants to monitor the status of and/or configure components of the cloud computing resources 418 allocated to that tenant. The administration tools 422 can also interface with the incident management unit 420 to provide means for notifying administrators and/or other authorized users of problems associated with one or more components of the cloud computing resources 418 that are experiencing issues that impact the services provided by the cloud-based computing environment 410. The web application 490 and/or the native application 414 of the client device 405 provide a user interface or user interfaces for accessing the administration tools provided by the administration tools 422 in some implementations.

The incident management unit 420 provides tools creating incident management tickets, for monitoring the status of incident management tickets, and for resolving incident management tickets. The incident management tickets identify problems with the cloud computing resources 418 that are impacting the services provided by the cloud-based computing environment 410. The incident management tickets can be generated by authorized users via a user interface provided by the native application 414 and/or the web application 490. The incident management tickets can also be generated by the JSON validator 304 as discussed in the preceding examples to identify incidents in which a JSON object string generated by or received by a component of the cloud computing resources 418 is invalid. Such incidents are indicative of a problem in which invalid data is being generated by or received by a component of the cloud computing resources 418. A technical benefit of this approach is that the system can automatically identify and create an incident report in response to invalid data being exchanged among components of the cloud computing resources 418 that may be indicative of a problem that can negatively impact the user experience by degrading the performance of the applications and/or services provided by the cloud-based computing environment 410.

The client device 405 is a computing device that may be implemented as a portable electronic device, such as a mobile phone, a tablet computer, a laptop computer, a portable digital assistant device, a portable game console, and/or other such devices in some implementations. The client device 405 may also be implemented in computing devices having other form factors, such as a desktop computer, a kiosk, a point-of-sale system, a video game console, and/or other types of computing devices in other implementations. While the example implementation illustrated in FIG. 4 includes a single client device 405, other implementations may include a different number of client devices that utilize services provided by the cloud-based computing environment 410.

The client device 405 includes a native application 414 and a browser application 412. The native application 414 is a web-enabled native application, in some implementations, implements an application that can utilize and/or manage the services of the cloud computing resources 418. The browser application 412 can be used for accessing and viewing web-based content provided by the cloud-based computing environment 410. In such implementations, the cloud-based computing environment 410 implements one or more web applications, such as the web application 490. The cloud-based computing environment 410 supports both the native application 414 and a web application 490 in some implementations, and the users may choose which approach best suits their needs.

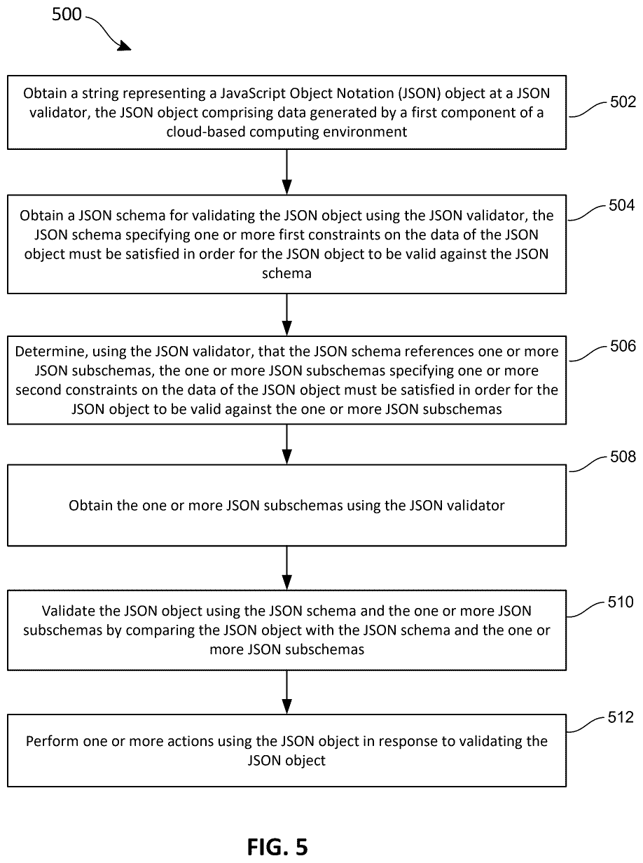

FIG. 5 is an example flow chart of an example process 500 for validating a JSON object using a multilayer JSON schema according to the techniques described herein. The process 500 can be implemented by the JSON validator 304 discussed in the preceding examples.

The process 500 includes an operation 502 of obtaining a string representing a Javascript Object Notation (JSON) object at a JSON validator. The JSON object string 302 comprises data generated by a first component of a cloud-based computing environment which is to be sent to a second component of the cloud-based computing environment in some implementations.

The process 500 includes an operation 504 of obtaining a JSON schema for validating the JSON object using the JSON validator. The JSON schema specifies one or more first constraints on the data of the JSON object which must be satisfied in order for the JSON object to be valid against the JSON schema. The JSON validator 304 can select the JSON schema from the JSON schemas 306 stored in a memory of the cloud-based computing environment 410. The JSON validator 304 can select the JSON schema from among the JSON schemas 306.

The process 500 includes an operation 506 of determining, using the JSON validator, that the JSON schema references one or more JSON subschemas, the one or more JSON subschemas specifying one or more second constraints on the data of the JSON object which must be satisfied in order for the JSON object to be valid against the one or more JSON subschemas, and an operation 508 of obtaining the one or more JSON subschemas using the JSON validator 304. As discussed above, the JSON validator 304 supports multilayer JSON schemas. The JSON validator 304 recognizes that the JSON schema references one or more subschemas. The one or more subschemas can also reference one or more subschemas.

The process 500 includes an operation 510 of validating the JSON object using the JSON schema and the one or more JSON subschemas by comparing the JSON object with the JSON schema and the one or more JSON subschemas and an operation 512 of performing one or more actions using the JSON object in response to validating the JSON object. As discussed in the preceding examples, the JSON validator 304 can take various actions in response to the JSON object being invalid, such as but not limited to creating an incident report with the incident management unit 420 indicating that an error has occurred. The JSON validator 304 can also take various actions in response to the JSON object being valid, such as but not limited to sending the JSON object to a component of the cloud computing resource 418 or otherwise processing the JSON object.

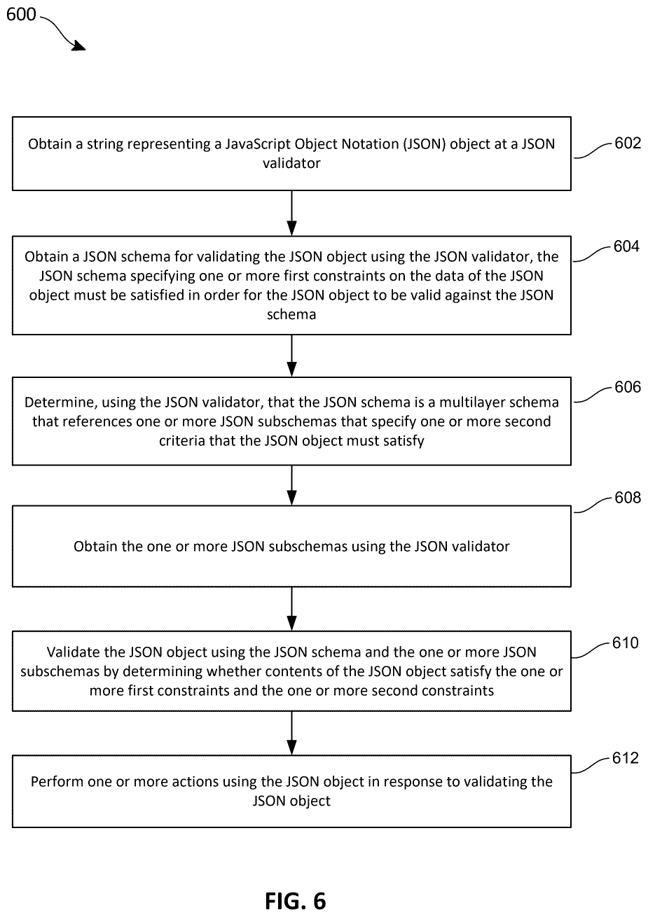

FIG. 6 is an example flow chart of another example process for validating a JSON object using a multilayer JSON schema according to the techniques described herein. The process 600 can be implemented by the JSON validator 304 discussed in the preceding examples.

The process 600 includes an operation 602 of obtaining a string representing a JSON object at a JSON validator. The JSON object can comprise data generated by a first component of a cloud-based computing environment which is to be sent to a second component of the cloud-based computing environment in some implementations.

The process 600 includes an operation 604 of obtaining a JSON schema for validating the JSON object using the JSON validator. The JSON schema specifies one or more first constraints on the data of the JSON object which must be satisfied in order for the JSON object to be valid against the JSON schema. The JSON validator 304 can select the JSON schema from the JSON schemas 306 stored in a memory of the cloud-based computing environment 410. The JSON validator 304 can select the JSON schema from among the JSON schemas 306.

The process 600 includes an operation 606 of determining, using the JSON validator, that the JSON schema is a multilayer schema that references one or more JSON subschemas that specify one or more second criteria that the JSON object must satisfy and an operation 608 of obtaining the one or more JSON subschemas using the JSON validator. As discussed above, the JSON validator 304 supports multilayer JSON schemas. The JSON validator 304 recognizes that the JSON schema references one or more subschemas. The one or more subschemas can also reference one or more subschemas.

The process 600 includes an operation 610 of validating the JSON object using the JSON schema and the one or more JSON subschemas by determining whether contents of the JSON object satisfy the one or more first constraints and the one or more second constraints and an operation 612 of performing one or more actions using the JSON object in response to validating the JSON object. As discussed in the preceding examples, the JSON validator 304 can take various actions in response to the JSON object being invalid, such as but not limited to creating an incident report with the incident management unit 420 indicating that an error has occurred. The JSON validator 304 can also take various actions in response to the JSON object being valid, such as but not limited to sending the JSON object to a component of the cloud computing resource 418 or otherwise processing the JSON object.

The detailed examples of systems, devices, and techniques described in connection with FIGS. 1A-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1A-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

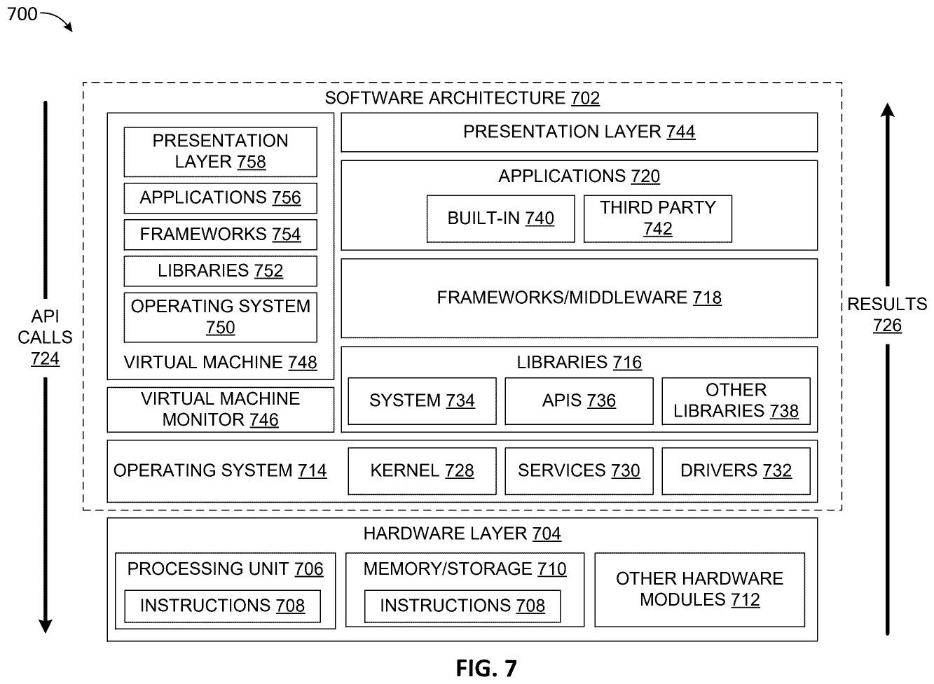

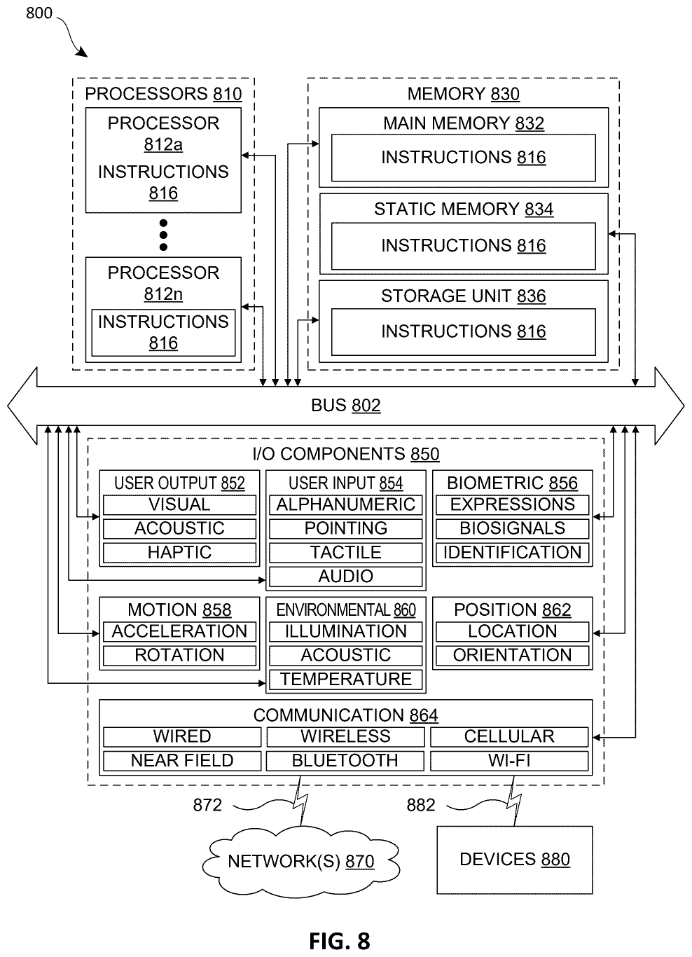

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium”excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a machine-readable medium storing executable instructions that, when executed, cause the processor alone or in combination with other processors to perform operations comprising:
obtaining a string representing a data object at a validator, the data object comprising data generated by a first component of a cloud-based computing environment;
obtaining a schema for validating the data object using the validator, the schema specifying one or more first constraints on the data of the data object which must be satisfied in order for the data object to be valid against the JSON schema;
determining, using the validator, that the schema references one or more subschemas, the schema including a template schema that the one or more subschemas must follow, and the one or more subschemas being reusable and interchangeable and specifying one or more second constraints on the data of the data object which must be satisfied in order for the data object to be valid against the one or more subschemas;
obtaining the one or more subschemas using the validator;
validating, by the validator, the data object using the schema and the one or more subschemas by comparing the data object with the schema and the one or more subschemas and determining that the data object satisfies the first constraints specified by the schema and the second constraints specified by the subschemas; and
performing one or more actions using the data object in response to validating the data object.

2. The data processing system of claim 1, wherein performing the one or more actions using the data object in response to validating the data object further comprises:
generating an incident report with an incident management system in response to determining that the data object is invalid.

3. The data processing system of claim 1, wherein performing the one or more actions using the data object in response to validating the data object further comprises:
sending the data object to a second component of a cloud-based computing environment.

4. The data processing system of claim 1, wherein the machine-readable medium further includes instructions configured to cause the processor alone or in combination with other processors to perform operations of:
processing the data object using the first component of the cloud-based computing environment.

5. The data processing system of claim 1, wherein the validator is implemented by the first component of the cloud-based computing environment, and wherein the machine-readable medium further includes instructions configured to cause the processor alone or in combination with other processors to perform operations of:
instantiating an instance of the data object from the string,
wherein obtaining the schema for validating the data object further comprises executing a get schema method on the data object to obtain the schema and the one or more subschemas.

6. The data processing system of claim 5, wherein each subschema of the one or more subschemas is associated with a class of object of a plurality of classes of objects.

7. The data processing system of claim 6, wherein a first class of object of the plurality of classes of objects includes a member variable of second class of object of the plurality of classes of objects, and wherein a first schema associated with the first class of object references as a subschema a second schema associated with the second class of object.

8. The data processing system of claim 5, wherein the machine-readable medium further includes instructions configured to cause the processor alone or in combination with other processors to perform operations of:
iteratively instantiating an instance of each object associated with the one or more subschemas; and
calling a get schema method on the instance of each object to cause the object to load a schema associated with the object.

9. The data processing system of claim 1, wherein validating the data object using the schema and the one or more subschemas by comparing the data object with the schema and the one or more subschema further comprises:
determining that the data object is invalid if one or more properties indicated to be required by the schema or one or more subschemas is not present in the data object.

10. A method implemented in a data processing system for validating data, the method comprising:
obtaining a string representing a JavaScript Object Notation data object at a validator, the data object comprising data generated by a first component of a cloud-based computing environment;
obtaining a schema for validating the data object using the validator, the schema specifying one or more first constraints on the data of the data object which must be satisfied in order for the data object to be valid against the schema;
determining, using the validator, that the schema references one or more subschemas, the schema including a template schema that the one or more subschemas must follow, and the one or more subschemas being reusable and interchangeable and specifying one or more second constraints on the data of the data object which must be satisfied in order for the data object to be valid against the one or more subschemas;
obtaining the one or more subschemas using the validator;
validating, by the validator, the data object using the schema and the one or more subschemas by comparing the data object with the schema and the one or more subschemas and determining that the data object satisfies the first constraints specified by the schema and the second constraints specified by the subschemas; and
performing one or more actions using the data object in response to validating the data object.

11. The method of claim 10, wherein performing the one or more actions using the data object in response to validating the data object further comprises:
generating an incident report with an incident management system in response to determining that the data object is invalid.

12. The method of claim 10, wherein performing the one or more actions using the data object in response to validating the data object further comprises:
sending the data object to a second component of a cloud-based computing environment.

13. The method of claim 10, further comprising:
processing the data object using the first component of the cloud-based computing environment.

14. The method of claim 10, wherein the validator is implemented by the first component of the cloud-based computing environment, and the method further comprising:
instantiating an instance of the data object from the string,
wherein obtaining the schema for validating the data object further comprises executing a get schema method on the data object to obtain the schema and the one or more subschemas.

15. The method of claim 10, wherein each subschema of the one or more subschemas is associated with a class of object of a plurality of classes of objects.

16. The method of claim 15, wherein a first class of object of the plurality of classes of objects includes a member variable of second class of object of the plurality of classes of objects, and wherein a first schema associated with the first class of object references as a subschema a second schema associated with the second class of object.

17. A data processing system comprising:
a processor; and
a machine-readable medium storing executable instructions that, when executed, cause the processor alone or in combination with other processors to perform operations comprising:
obtaining a string representing a JavaScript Object Notation data object at a validator;
obtaining a schema for validating the data object using the validator, the schema specifying one or more first constraints on the data of the data object which must be satisfied in order for the data object to be valid against the schema;
determining, using the validator, that the schema is a multilayer schema that references one or more subschemas, the schema including a template schema that the one or more subschemas must follow, and the one or more subschemas being reusable and interchangeable and that specify one or more second constraints that the data object must satisfy;
obtaining the one or more subschemas using the validator;
validating, by the validator, the data object using the schema and the one or more subschemas by determining whether contents of the data object satisfy the one or more first constraints and the one or more second constraints; and
performing one or more actions using the data object in response to validating the data object.

18. The data processing system of claim 17, wherein performing the one or more actions using the data object in response to validating the JSON data object further comprises:
generating an incident report with an incident management system in response to determining that the object is invalid.

19. The data processing system of claim 17, wherein performing the one or more actions using the data object in response to validating the data object further comprises:
sending the data object to a second component of a cloud-based computing environment.

20. The data processing system of claim 17, wherein the machine-readable medium further includes instructions configured to cause the processor alone or in combination with other processors to perform operations of:
processing the data object using a first component of a cloud-based computing environment.
